(19) United States
(12) Patent Application Publication
(10) Pub. No.: US 2025/0282207 A1
(43) Pub. Date: Sep. 11, 2025

(54) FRONT WINDSHIELD FILM FOR VEHICLE

(71) Applicant: GUANGZHOU ISSYZONE TECHNOLOGY CO., LIMITED, Guangzhou (CN)

(72) Inventors: ZHUO JIA, Guangzhou (CN); TAIPING YANG, Shenzhen (CN)

(21) Appl. No.: 18/666,679

(22) Filed: May 16, 2024

(30) Foreign Application Priority Data
Mar. 7, 2024 (CN) 202420442093.2

(51) Int. Cl. B60J 11/08

(52) U.S. Cl. CPC B60J 11/08

(57) ABSTRACT

A front windshield film for vehicles is provided, which includes a windshield film and a filter film, two sides of the windshield film are provided with an installation webbing strap configured to be fixed on a target anti-roll frame, a front of the windshield film is provided with a velvet surface fixing strap, and a rear thereof is provided with a hook surface fixing strap matching the velvet surface fixing strap. The beneficial effect of the present application is that by providing the installation webbing strap on two sides of the windshield film, the windshield film is fixed on the target anti-roll frame, velvet surface fixing strap and hook surface fixing strap are provided on surfaces of the windshield film and filter film. When sunlight is too strong, a user can selectively and quickly attach the filter film to an inner side of the windshield film.

### CROSS-REFERENCE TO RELATED APPLICATIONS

This application claims priority to Chinese Patent Application No. 202420442093.2, filed on Mar. 7, 2024, which is hereby incorporated by reference in its entirety.

### TECHNICAL FIELD

The present disclosure relates to the field of front windshield film for vehicles technologies, and in particular, to a front windshield film for vehicles.

### BACKGROUND

The front of the anti-roll frame of the Utility Vehicle (UTV) is generally not equipped with a front windshield. This is because the usage scenario of this vehicle is usually on muddy or dusty road sections. If a front windshield is installed, raise sand will adhere to the glass and affects the sight view. Moreover, if it is cleared by the wiper alone, it needs to be continuously sprayed with water, and the water in the water tank is often not enough. In addition, sharp large solid particles are easily scratched by the wiper, which can also cause glass damage.

However, some users use UTV vehicles without front windshields in dust-free areas such as lawns, which cannot meet their windshield needs. Therefore, users need to purchase front windshields or transparent flexible plastic films for installation. However, the current windshields for vehicles on the market are all monochrome (such as transparent, brown, etc.), which can only meet the needs of a single scene (when there is strong sunlight or insufficient light), and their versatility is low.

### SUMMARY

In response to the above problems, the present disclosure proposes a front windshield film for vehicles, mainly solving the problem of a single usage scenario of existing windshield films.

To solve the above technical problems, the technical solution of the present disclosure is as follows.

A front windshield film for vehicles, including a windshield film and a filter film with the same length, where two sides of the windshield film are both provided with an installation webbing strap configured to be fixed on a target anti-roll frame, a front of the windshield film is provided with a velvet surface fixing strap, and a rear of the filter film is provided with a hook surface fixing strap that matches the velvet surface fixing strap.

In some embodiments, at least two sets of installation webbing straps are provided on either side of the windshield film.

In some embodiments, the installation webbing strap includes a first velvet surface webbing strap and a first hook surface webbing strap, where a length of the first hook surface webbing strap is greater than a length of the first velvet surface webbing strap.

In some embodiments, a width of the filter film is at least half of a width of the windshield film.

In some embodiments, the velvet surface fixing strap includes a first velvet surface fixing strap symmetrically provided on an upper of the windshield film and a second velvet surface fixing strap symmetrically provided on two sides of the windshield film; the first velvet surface fixing strap is provided along a length direction of the windshield film, the second velvet surface fixing strap is provided along a width direction of the windshield film, and the hook surface fixing strap includes a hook surface fixing strap and a second hook surface fixing strap that match positions of the first velvet surface fixing strap and the second velvet surface fixing strap.

In some embodiments, one side of the windshield film is further provided with two storage webbing straps, which are a second hook surface webbing strap and a third hook surface webbing strap from top to down; when the filter film is stored, the filter film is curled unidirectionally in a direction of the storage webbing straps, and the second hook surface webbing strap is fixed and aligned with the first velvet surface fixing strap, the third hook surface webbing strap is fixed and aligned with the second velvet surface fixing strap.

In some embodiments, the velvet surface fixing strap and the hook surface fixing strap are respectively hot fused onto surfaces of the windshield film and the filter film.

In some embodiments, a side frame is provided on two sides of the windshield film, an elastic rod is embedded inside the side frame.

In some embodiments, lower edges of the windshield film are respectively provided with a lower border, and a lower edge of the lower border is provided with a guide film.

In some embodiments, the guide film is a PVC transparent film.

### BRIEF DESCRIPTION OF DRAWINGS

FIG. 1 is a schematic diagram of a split structure of a front windshield film for vehicles disclosed in an embodiment of the present disclosure.

FIG. 2 is a schematic diagram of an installation process of a filter film disclosed in an embodiment of the present disclosure.

FIG. 3 is a schematic diagram of a storage process of the filter film disclosed in an embodiment of the present disclosure.

FIG. 4 is a structural schematic diagram of the filter film after storage disclosed in an embodiment of the present disclosure.

Numeral reference: 1—Windshield film, 2—Filter film, 3—Installing webbing strap, 4—Velvet surface fixing strap, 5—Hook surface fixing strap, 6—Storage webbing strap, 7—Side frame, 8—Elastic rod, 9—Lower border, 301—First velvet surface webbing strap, 302—First hook surface webbing strap, 401—First velvet surface fixing strap, 402—Second velvet surface fixing strap, 501—First hook surface fixing strap, 502—Second hook surface fixing strap, 601—Second hook surface webbing strap, 602—Third hook surface webbing strap.

### DESCRIPTION OF EMBODIMENTS

In order to make the purpose, technical solution, and advantages of the present disclosure clearer and more specific, the following will provide further detailed explanations of the description of the present disclosure in combination with the accompanying drawings and specific embodiment. It can be understood that the specific embodiments described here are only intended to explain the present disclosure and not to limit it. Furthermore, it should be noted that for ease of description, only relevant parts of the present disclosure are shown in the accompanying drawings, rather than the entire content.

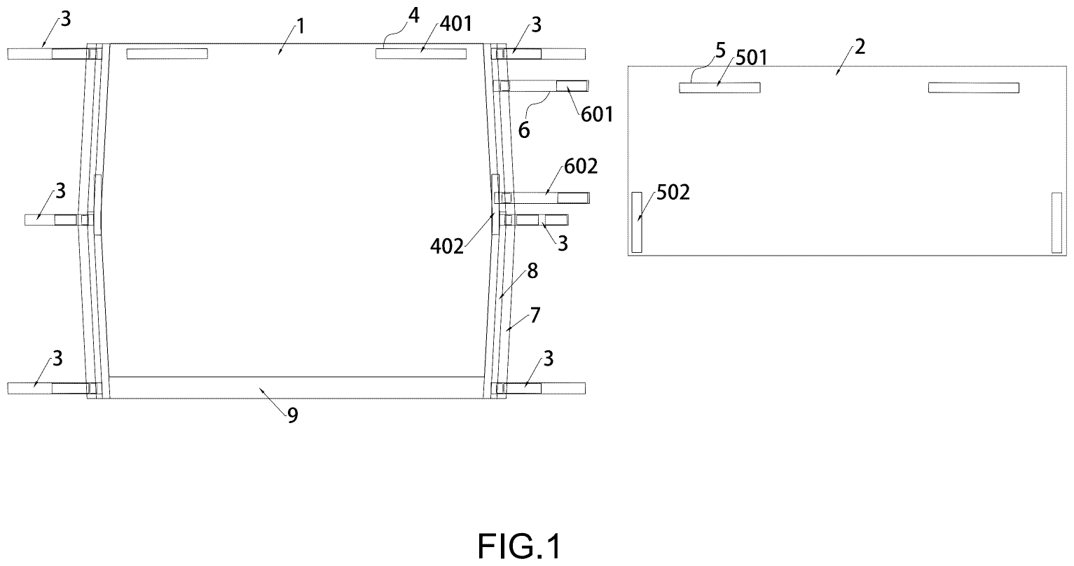

This embodiment proposes a front windshield film for vehicles, as shown in FIG. 1, which includes a windshield film 1 and a filter film 2 with the same length. Two sides of the windshield film 1 are provided with an installation webbing strap 3 configured to be fixed to a target anti-roll frame. Additionally, a front of the windshield film 1 is provided with a velvet surface fixing strap 4, and a rear of the filter film 2 is provided with a hook surface fixing strap 5 that matches the velvet surface fixing strap 4.

In this embodiment, by providing the installation webbing strap 3 on two sides of the windshield film 1, the windshield film 1 is fixed on the target anti-roll frame, and the velvet surface fixing strap 4 and hook surface fixing strap 5 with corresponding positions and sizes are provided on surfaces of the windshield film 1 and the filter film 2. When sunlight is too strong, a user can selectively and quickly attach the filter film 2 to an inner side of the windshield film 1, thereby attenuating an intensity of an incident light entering from the windshield film 1 and increasing a product's usage scenario.

It should be noted that the target anti-roll frame described in this embodiment refers to a pillar A of the UTV. Therefore, the installation webbing strap 3 can be used to fix the windshield film 1 on two pillars A, thereby forming an effective fixed connection. In addition, the velvet surface fixing strap 4 and hook surface fixing strap 5 described in this embodiment are double-sided structures of Velcro. When subjected to a certain tension, a hook of the hook surface fixing strap 5 can be straightened and released from a velvet ring of the velvet surface fixing strap 4. When the hook detaches from the velvet ring, it can restore an original hook shape and be reused.

Furthermore, it should be noted that after the installation of windshield film 1, the velvet surface fixing strap 4 on its surface should face towards a compartment. Correspondingly, when the filter film 2 is installed on the surface of windshield film 1 through the hook surface fixing strap 5, as the filter film 2 does not directly face the wind, it is not easy for it to fall off.

In an embodiment, at least two sets of installation webbing straps 3 are provided on either side of the windshield film 1. Obviously, the number of installation webbing straps 3 is related to a fixation stability of the windshield film 1, as shown in FIG. 1. Three installation webbing straps 3 are provided on each side of the windshield film 1. In order to improve the convenience of loading and unloading the installation webbing strap 3, the above-mentioned installation webbing strap 3 includes a first velvet surface webbing strap 301 and a first hook surface webbing strap 302. The two webbing straps are connected as a whole with the principle of Velcro, where a length of the first hook surface webbing strap 302 is greater than that of the first velvet surface webbing strap 301. This setting method considers that the installation webbing strap 3 requires wounding at least one circle around the target anti-roll frame to form an effective fixation, so the length of the first hook surface webbing strap 302 needs to be greater than that of the first velvet surface webbing strap 301. In an embodiment, roots of the first velvet surface webbing strap 301 and the first hook surface webbing strap 302 can be fixed at the same position on one side of the windshield film 1 to reduce production steps.

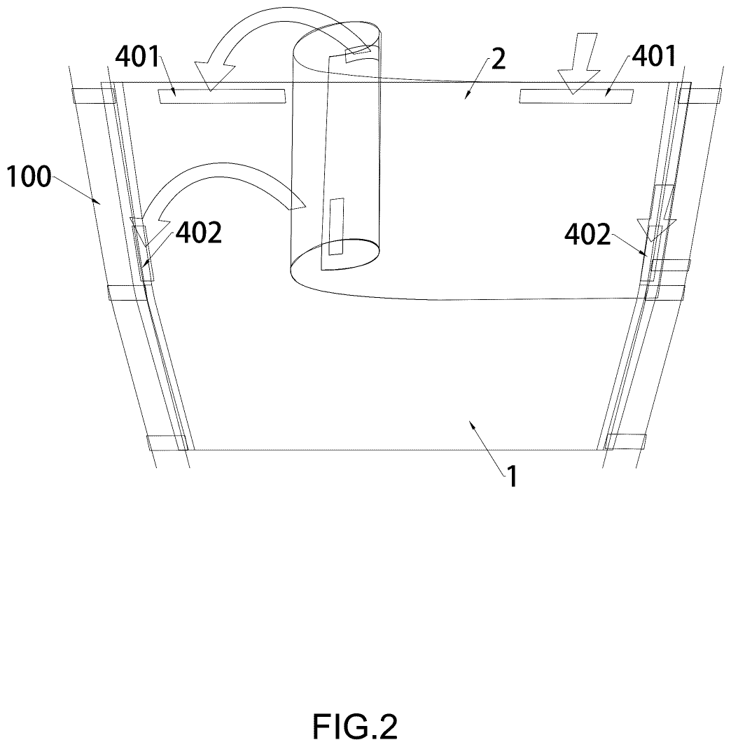

To ensure a filtering effect of filter film 2, a width of filter film 2 should be at least half of a width of windshield film 1, as shown in FIG. 2. The filter film 2 is installed on an upper of the windshield film 1 to avoid strong light interference to the user's eyes while driving.

The installation positions of the velvet surface fixing strap 4 and hook surface fixing strap 5 mentioned above can be freely set by technical personnel to achieve the fixation of the filter film 2. In an example, the velvet surface fixing strap 4 includes a first velvet surface fixing strap 401 symmetrically provided on an upper of the windshield film 1, and a second velvet surface fixing strap 402 symmetrically provided on two sides of edges of the windshield film 1. The first velvet surface fixing strap 401 is provided along a length direction of the windshield film 1, the second velvet surface fixing strap 402 is provided along a width direction of the windshield film 1, and the hook surface fixing strap 5 includes a first hook surface fixing strap 501 and a second hook surface fixing strap 502 that match positions of the first velvet surface fixing strap 401 and second velvet surface fixing strap 402. In this scheme, as shown FIGS. 1 and 2, two sets of Velcro (each set consisting of a first velvet surface fixing strap 401 and a first hook surface fixing strap 501) are used for fixing the upper of windshield film 1 and filter film 2, respectively. The other two sets of Velcro (each set consisting of a second velvet surface fixing strap 402 and a second hook surface fixing strap 502) are used for fixing left and right sides of windshield film 1 and filter film 2, respectively.

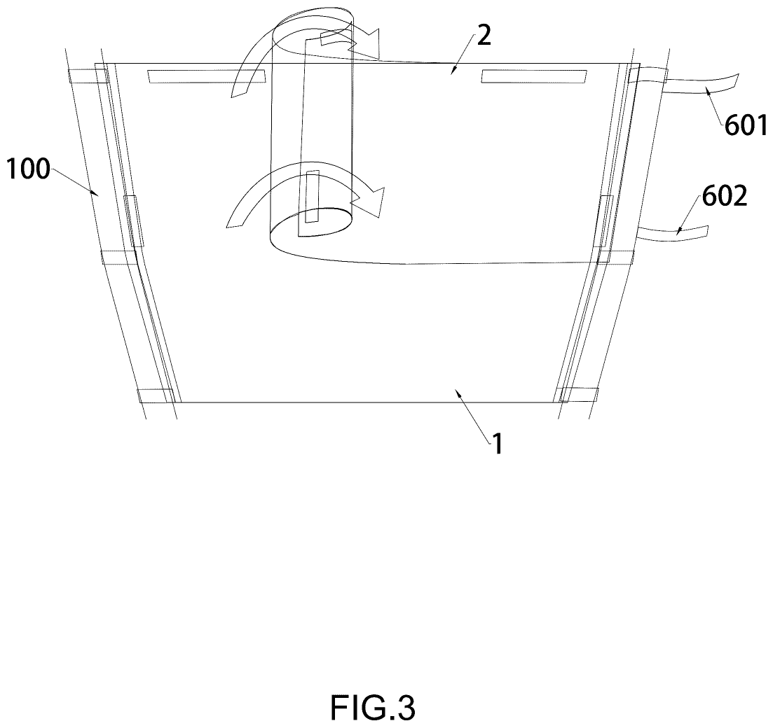

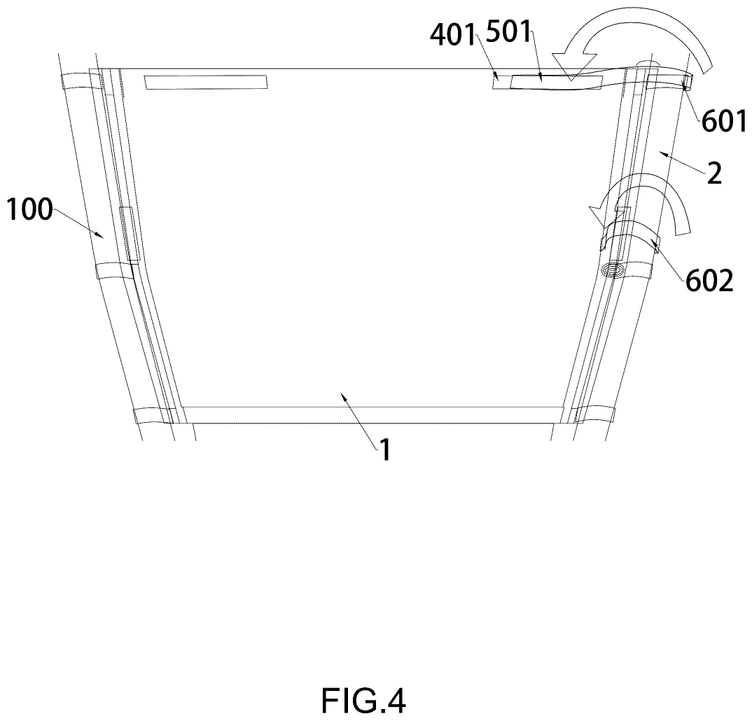

As another important invention point of the present disclosure, one side of the windshield film 1 is further provided with two storage webbing straps 6, which are a second hook surface webbing strap 601 and a third hook surface webbing strap 602 in a top-down order. When the filter film 2 is stored, it curls unidirectionally in a direction of the storage webbing straps 6, the third hook surface webbing strap 602 and the first velvet surface fixing strap 401 are fixed and aligned, and then the third hook surface webbing strap 602 and the second velvet surface fixing strap 402 are fixed and aligned. Based on the above example, when it is necessary to store the filter film 2, it is curled unidirectionally in the direction of the storage webbing straps 6. At this time, three sets of Velcro are required (two sets of Velcro consisting of the first velvet surface fixing strap 401 and the first hook surface fixing strap 501, and one set of Velcro far away from the storage webbing strap 6 consisting of the second velvet surface fixing strap 402 and the second hook surface fixing strap 502). As shown in FIG. 3, the curled cylindrical filter film 2 only relies on one set of Velcro close to the storage webbing strap 6 consisting of the second velvet surface fixing strap 402 and the second hook surface fixing strap 502. The formed Velcro is longitudinally fixed, and finally, as shown in FIG. 4, the second hook surface webbing strap 601 and the third hook surface webbing strap 602 are respectively adhered to the first velvet surface fixing strap 401 and the second velvet surface fixing strap 402 to prevent the curled filter film 2 from bouncing off.

Obviously, in the above scheme, when the filter film 2 is installed on the windshield film 1, the first velvet surface fixing strap 401 and the second velvet surface fixing strap 402 serve as connection points that match the first hook surface fixing strap 501 and the second hook surface fixing strap 502. When the filter film 2 needs to be stored, the first velvet surface fixing strap 401 and the second velvet surface fixing strap 402 need to be combined with the second hook surface webbing strap 601 and the third hook surface webbing strap 602 to bind the filter film 2 in a radial manner.

In an embodiment, the velvet surface fixing strap 4 and the hook surface fixing strap 5 are hot fused onto surfaces of the windshield film 1 and the filter film 2 respectively, aiming to improve the waterproofing of the windshield film 1 and the filter film 2. The conventional manner of connecting the magic hook hair to the fabric is through sewing thread, and needle hole can be penetrated by water. High frequency voltage can fuse the magic hook hair to the windshield film 1 and filter film 2 made of PVC material. The magic hook hair and filter film are integrated, so the design without needle holes will not leak water.

To optimize the use stability of the windshield film 1, a side frame 7 is provided on two sides of edges of windshield film 1, and an elastic rod 8 is embedded in the side frame 7. This solution supports the side edges of windshield film 1 by providing with the elastic rod 8, which can avoid a collapse of an entire windshield film 1 due to a lack of support after the installation webbing strap 3 slips off.

In an embodiment, lower edges of the windshield film 1 are respectively provided with a lower border 9, and a lower edge of the lower border is provided with a guide film (not shown in the figure). The guide film is a PVC transparent film, which blocks the airflow directly in front of the compartment.

The above embodiments are only intended to illustrate the technical concept and characteristics of the present disclosure. The purpose is to those skilled in the art to understand the content of the present disclosure and implement it accordingly, and cannot limit the protection scope of the present disclosure. Any equivalent changes or modifications made based on the essence of the content of the present disclosure should be covered within the protection scope of the present disclosure.

What is claimed is:

1. A front windshield film for vehicles, comprising a windshield film and a filter film with the same length, wherein two sides of the windshield film are both provided with an installation webbing strap configured to be fixed on a target anti-roll frame, a front of the windshield film is provided with a velvet surface fixing strap, and a rear of the filter film is provided with a hook surface fixing strap that matches the velvet surface fixing strap.

2. The front windshield film for vehicles as claimed in claim 1, wherein at least two sets of installation webbing straps are provided on either side of the windshield film.

3. The front windshield film for vehicles as claimed in claim 1, wherein the installation webbing strap comprises a first velvet surface webbing strap and a first hook surface webbing strap, wherein a length of the first hook surface webbing strap is greater than a length of the first velvet surface webbing strap.

4. The front windshield film for vehicles as claimed in claim 3, wherein a width of the filter film is at least half of a width of the windshield film.

5. The front windshield film for vehicles as claimed in claim 4, wherein the velvet surface fixing strap comprises a first velvet surface fixing strap symmetrically provided on an upper of the windshield film and a second velvet surface fixing strap symmetrically provided on two sides of the windshield film; the first velvet surface fixing strap is provided along a length direction of the windshield film, the second velvet surface fixing strap is provided along a width direction of the windshield film, and the hook surface fixing strap comprises a hook surface fixing strap and a second hook surface fixing strap that match positions of the first velvet surface fixing strap and the second velvet surface fixing strap.

6. The front windshield film for vehicles as claimed in claim 5, wherein one side of the windshield film is further provided with two storage webbing straps, which are a second hook surface webbing strap and a third hook surface webbing strap from top to down; when the filter film is stored, the filter film is curled unidirectionally in a direction of the storage webbing straps, and the second hook surface webbing strap is fixed and aligned with the first velvet surface fixing strap, the third hook surface webbing strap is fixed and aligned with the second velvet surface fixing strap.

7. The front windshield film for vehicles as claimed in claim 1, wherein the velvet surface fixing strap and the hook surface fixing strap are respectively hot fused onto surfaces of the windshield film and the filter film.

8. The front windshield film for vehicles as claimed in claim 1, wherein a side frame is provided on two sides of the windshield film, an elastic rod is embedded inside the side frame.

9. The front windshield film for vehicles as claimed in claim 1, wherein lower edges of the windshield film are respectively provided with a lower border, and a lower edge of the lower border is provided with a guide film.

10. The front windshield film for vehicles as claimed in claim 9, wherein the guide film is a PVC transparent film.
